(19) United States
(12) Patent Application Publication
(10) Pub. No.: US 2008/0222505 A1
(43) Pub. Date: Sep. 11, 2008

(54) METHOD OF CAPTURING A PRESENTATION AND CREATING A MULTIMEDIA FILE

(76) Inventor: David Chmura, Ann Arbor, MI (US)

Correspondence Address: SCHOX PLC, 730 Florida Street #2, San Francisco, CA, 94110, US

(21) Appl. No.: 11/970,903

(22) Filed: Jan. 8, 2008

Related U.S. Application Data
(60) Provisional application No. 60/883,955, filed on Jan. 8, 2007.

(51) Int. Cl. G06F 17/00

(52) U.S. Cl. 715/202

(57) ABSTRACT

According to the preferred embodiment of the invention, the method of capturing a presentation from a presentation program and creating a multimedia file includes the steps of capturing an audio file having a time structure; capturing user commands for the presentation program; creating chapters and assigning chapter markers within the time structure of the audio file based on the timing of the user commands; receiving an image set associated with the presentation; associating a particular image of the image set with a particular chapter of the audio file based on the timing of the user commands, and creating a multimedia file based on the audio file, the assigned chapter markers, and the associated images.

### CROSS-REFERENCE TO RELATED APPLICATIONS

This application claims the benefit of U.S. Provisional Application No. 60/883,955 filed on 8 Jan. 2007 and entitled “Method of Capturing a Presentation and Creating a Multimedia File”, which is incorporated in its entirety by this reference.

### BACKGROUND

Live presentations are an important tool to deliver knowledge and experience in educational and corporate settings. Not everyone who would like to attend the live presentation, however, can actually attend. To accommodate these people, the institutions may record the live presentation and offer the recording for download (or purchase). Alternatively, the presenters may offer their presentation for download, which typically consists of an image set (known as “slides”) in a presentation software (such as MICROSOFT PowerPoint or APPLE Keynote). Both of these methods, unfortunately, have serious shortcomings. The recording of a live presentation requires significant effort to setup, record, edit, and post the recording and the resultant recording often fails to capture the visual images of the presentation with enough clarity to be legible. The sharing of a PowerPoint file, while relatively easy, fails to capture the audio of the presentation, which typically carries the real content and true meaning of the live presentation. Thus, there is a need to create a new and useful method of capturing a presentation and creating a multimedia file that overcomes these shortcomings.

### BRIEF DESCRIPTION OF THE FIGURES

FIG. 1 is a schematic of the method of the preferred embodiment.

FIG. 2 is a flowchart of the method of the preferred embodiment.

FIG. 3 is a more-detailed schematic of the method of the preferred embodiment.

FIG. 4 is an example of the slides and metadata that combine with an audio source to create a multimedia file according to the method of the preferred embodiment.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

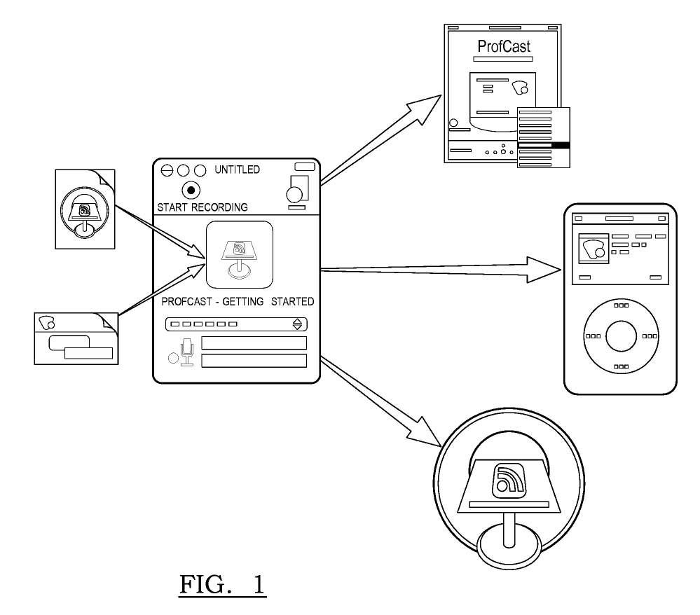

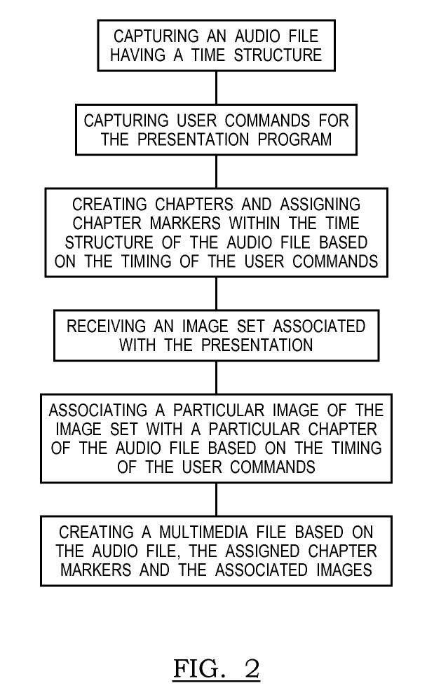

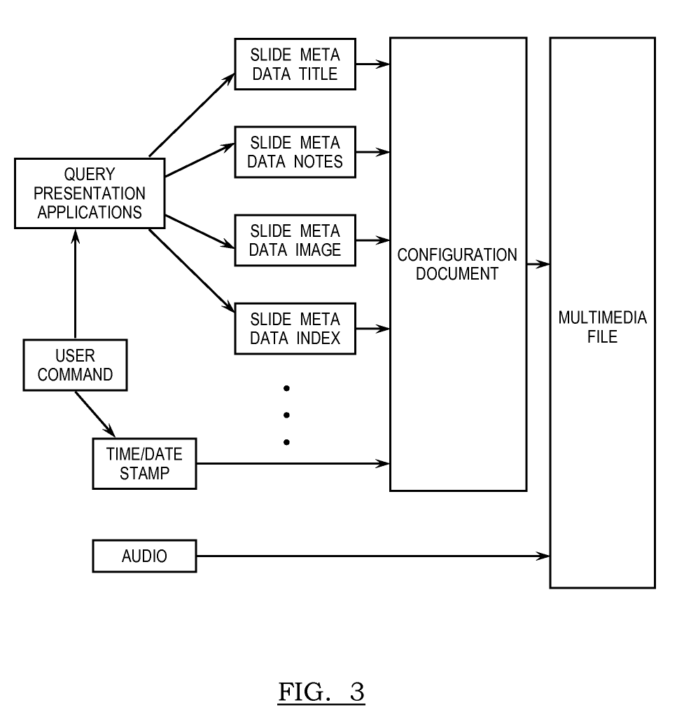

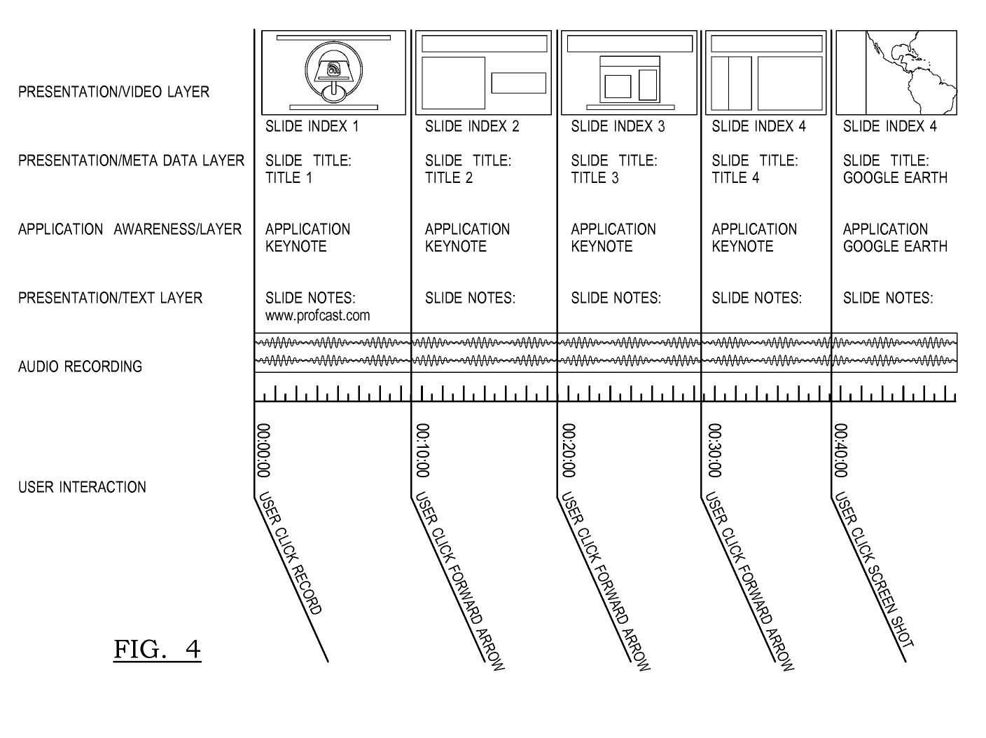

As shown in FIGS. 1-4, the method of capturing a presentation and creating a multimedia file of the preferred embodiment includes: (a) correlating user commands of a presentation program to a time structure, (b) receiving an image set of multiple images, (c) receiving audio file with a time structure, (d) creating chapters and assigning chapter markers within the time structure of the audio based on the time structure of the user commands, (e) associating particular images of the image set with the chapters based on the user commands, and (f) creating a multimedia file based on the audio, the chapter markers, and the particular images. The method of the invention has been specifically designed to capture a slide-based presentation (such as MICROSOFT PowerPoint or APPLE Keynote) and create a multimedia file (such as an “enhanced podcast”) with the essence of the presentation such that the presentation can be time and place shifted and experienced by others. The method may, however, be used for any suitable reason.

The step of correlating user commands of a presentation program to a time structure preferably includes “spying” on the presentation program and correlating user commands such as “next” and “back” against a timeline. Preferably, the method includes calling the presentation program in the foreground, while “spying” in the background. The advantage of this approach is the continuation of the presentation program even during a failure of the capturing the presentation, and the emphasis on the “live performance” aspect of giving a presentation. Alternatively, the method may include running the presentation program. The step of correlating user commands of a presentation program to a time structure may, however, be accomplished through any other suitable method or device.

The step of receiving an image set of multiple images preferably includes an automatic request of the exportation of the image set from the presentation program. The image set may include images of the slides of the presentations in JPEG, PNG, or any other suitable format. The step of receiving an image set may, however, be accomplished through any other suitable method or device.

The step of receiving audio file with a time structure functions to capture the voice narration of the presentation. The step preferably includes receiving the audio file from a built-in or external microphone, but may alternatively receive the audio file from any suitable method or device, such as an auditorium sound system. The audio file preferably includes a time structure.

The steps of creating chapters and assigning chapter markers within the time structure of the audio based on the time structure of the user commands and associating particular images of the image set with the chapters based on the user commands function to correlate the voice narration to the particular slides of the presentation. In one variation, a new chapter may be created with every user command. Every “next” command may, for example, create a new chapter of the audio file. In another variation, a new chapter may be created based on certain logic. Every “next” command followed by a voice narration of more than two seconds may, for example, create a new chapter of the audio file. As an example, given an image set with four images and the following user commands:

| Time | User Command |
|---|---|
| 1 min | “next” |
| 2 min | “next” |
| 2 min 30 sec | “back” |
| 4 min | “next”, “next” |

the following chapters are preferably created and the following images are preferably assigned:

| Chapter | Time | Assigned Image |
|---|---|---|
| 1 | start | 1 |
| 2 | 1 min | 2 |
| 3 | 2 min | 3 |
| 4 | 2 min 30 sec | 2 |
| 5 | 4 min | 4 |

The steps of creating chapters and assigning chapter markers within the time structure of the audio based on the time structure of the user commands and associating particular images of the image set with the chapters based on the user commands may, however, be accomplished through any other suitable method or device.

The step of creating a multimedia file based on the audio, the chapter markers, and the particular images functions to create a multimedia file with the essence of the presentation such that the presentation can be time and place shifted and experienced by others. The multimedia file is preferably an “enhanced podcast” file. An enhanced podcast is a multimedia format that allows images to be displayed in time with audio. This can be an effective way to present information such as lectures with a PowerPoint-like slide show. Enhanced podcasts are also able to present chapter markers in an audio file much like a DVD movie can allow users to jump to predetermined spots in a presentation. This can be helpful for longer audio presentations and audiobooks.

The method may further include creating titles for the chapters based on the (1) metadata of the particular image, (2) title of the particular image, (3) text embedded within the particular image, or any other appropriate data from the particular image and/or within the timeline. As an example, the title may be extracted from the “title section” of a slide in a MICROSOFT PowerPoint or APPLE Keynote presentation. The method may also include creating links to particular URLs based on the (1) notes associated with a particular image, or (2) URLs embedded within the particular image. The method may also include creating a text track (or lyric track) that could include the transcript for the spoken word for that slide or any other supplementary information for the chapter, which may be increase the accessibility of the multimedia file. The method may additionally include one or more steps to allow a user to edit the titles for the chapters, edit the URLs, re-order the images, resize or otherwise modify the images, change the time structure of the chapter markers, or allow any other suitable edit of the multimedia file.

As a first variation of the preferred embodiment, the method may include capturing images in addition to, or as substitute for, receiving an image set of multiple images. The images may be captured from the output of the presentation program, from the output of another program, from the computer output to the display, from a particular window or any other portion of the computer output to the display, or from any other suitable internal or external source. The method preferably includes associating particular images of the captured images with the chapters based on the user commands. If the method includes both receiving an image set and capturing images from another source, then the method may result in more than one image for a chapter. Preferably, the method includes combining the images, such as split-screen or overlay. Alternatively, the method may include creating an additional chapter, assigning one image to the original chapter and the other image to the new chapter. The method may further include allowing the user to select between the multiple images, or may automatically select between the multiple images based on either simple rules (such as the images received from the presentation program trumps all other images, or vice-versa) or based on complex rules (such as the analysis of the content of the images).

As a second variation of the preferred embodiment, the method may include receiving video files. The step functions to capture, not only the voice narration, but the movements and facial expressions by the presenter or the payback of animated demonstrations or pre-recorded video (such as motion video of medical procedures or physics demonstrations). The step preferably includes receiving the video file from a built-in or external video camera, but may alternatively receive the video file from an internal video mechanism or player or any suitable method or device. The video file preferably includes a time structure. The video file may be in addition to, or substitute for, the audio file. The images from the image set (or the capture images) may be combined with the video file. Preferably, the method includes combining the video and images, such as split-screen or overlay. Alternatively, the method may include allowing the user to select between the video and the images, or may automatically select between the two based on either simple rules (such as the images received from the presentation program are inserted into the video for five seconds) or based on complex rules (such as the analysis of the content of the images). Further, the selection between the two may be accomplished in near real time by a member of the audience (such as a so-called teaching assistant or TA), and the information captured by this member may be used to create the multimedia file.

As a third variation of the preferred embodiment, the method may include the following additional steps: (1) receiving a text file in a time structure from a member of the audience (such as a student or attendee), and (2) combining the information of the text file into the multimedia file. In a first implementation, the text of the text file is combined with the images or video using split-screen, overlay, or any other suitable method. In a second implementation, the text of the text file is converted into speech and the speech file is combine with the audio file using splitting techniques (such as left vs. right), combining techniques (such as low tones vs. high tones), or any other suitable method.

As a person skilled in the art will recognize from the previous detailed description and from the figures and claims, modifications and changes can be made to the preferred embodiments of the invention without departing from the scope of this invention defined in the following claims.

I claim:

1. A method of capturing a presentation from a presentation program and creating a multimedia file comprising the steps of:
capturing an audio file having a time structure;
capturing user commands for the presentation program;
creating chapters and assigning chapter markers within the time structure of the audio file based on the timing of the user commands;
receiving an image set associated with the presentation;
associating a particular image of the image set with a particular chapter of the audio file based on the timing of the user commands, and
creating a multimedia file based on the audio file, the assigned chapter markers, and the associated images.

2. The method of claim 1, wherein the step of capturing an audio file includes receiving the audio file from a microphone.

3. The method of claim 1, wherein the step of capturing user commands includes calling the presentation program in the foreground, while “spying” on the presentation program in the background.

4. The method of claim 1, wherein the step of capturing user commands includes capturing user commands that advance the presentation in the presentation program.

5. The method of claim 4, wherein the step of creating chapters and assigning chapter markers includes the step of creating chapters and assigning chapter markers within the time structure of the audio file based on the capturing of user commands that advance the presentation in the presentation program.

6. The method of claim 1, wherein step of receiving an image set includes requesting the exportation of the image set from the presentation program.

7. The method of claim 1, wherein the step of receiving an image set includes receiving a slide set of the presentation from the presentation program.

8. The method of claim 7, wherein the step of associating a particular image of the image set includes associating a particular slide of the slide set with a particular chapter of the audio file based on the timing of the user commands.

9. The method of claim 1, further comprising creating a title for a particular chapter based on metadata from the associated slide.

10. The method of claim 1, wherein the step of creating a multimedia file includes creating an “enhanced podcast” file.

11. The method of claim 1, wherein step of creating a multimedia file includes creating a multimedia file that adheres to a standard from the group consisting of .m4a, m4b, and .mov.

12. The method of claim 1, further comprising creating a titles for the chapters, wherein the step of creating titles includes extracting text from the image associated with a particular chapter.

13. The method of claim 1, further comprising the steps of facilitating edits of the multimedia file.

14. The method of claim 13, wherein the step of facilitating edits of the multimedia file includes facilitating modification of the timing of the chapter markers and the order of the association of the images.

15. The method of claim 1, wherein the step of capturing an audio file having a time structure further includes capturing a video file having a time structure.

16. The method of claim 15, wherein the step of capturing the video file includes receiving the video file from a video camera.

17. The method of claim 15, wherein the step of associating a particular image of the image set with a particular chapter further includes associating a particular portion of the video with a particular chapter of the audio file based on the timing of the user commands, wherein—within a particular chapter—an associated image and the associated video are combined.

18. The method of claim 17, wherein—within a particular chapter—an associated image and the associated video are combined in a simultaneous, split-screen manner.

19. The method of claim 17, wherein—within a particular chapter—an associated image and the associated video are combined in a time sequential manner.

20. The method of claim 19, wherein—within a particular chapter—an associated image and the associated video are combined in a time sequential manner that includes selecting the image for a predetermined time period and then switching to the video for the remainder of the chapter.
